(19) United States
(12) Patent Application Publication
(10) Pub. No.: US 2024/0269679 A1
(43) Pub. Date: Aug. 15, 2024

(54) SMALL SCALE REACTOR

(71) Applicant: Singh Instrument LLC, Livermore, CA (US)

(72) Inventors: Robbie Singh Sidhu, Livermore, CA (US); Eric Dias, Livermore, CA (US); John Flexer Walzer, JR., Livermore, CA (US); Richard Fisher, Livermore, CA (US)

(21) Appl. No.: 18/441,568

(22) Filed: Feb. 14, 2024

Related U.S. Application Data
(60) Provisional application No. 63/484,846, filed on Feb. 14, 2023.

(51) Int. Cl. B01L 3/00; B01L 9/06

(52) U.S. Cl. CPC B01L 3/565; B01L 9/065; B01L 2300/045; B01L 2300/08; B01L 2400/043

(57) ABSTRACT

A small scale reactor includes a seal gate for closing an interior of a test cell in the reactor. The seal gate protects elastomeric seals in an injection port from the effluent from the test cell. A stirrer of the small scale reactor has a clip on magnet that allows for easy replacement. A drive system of the small scale reactor does not have to be disconnected when the test cells are opened to permit access for placing or retrieving the vials in the reactor.

### STATEMENT OF RELATED CASES

This application claims priority to U.S. Provisional Patent Application No. 63/484,846, filed Feb. 14, 2023, which is hereby incorporated by reference in its entirety.

### FIELD OF INVENTION

This invention relates generally to small-scale laboratory reactors.

### BACKGROUND OF THE INVENTION

It is known to provide small scale reactors with a feature that permits other substances, such as other chemical reactants, to be introduced into the test vial in the reactor. The individual test cells have a small opening to a surrounding environment that is closed by a valve. Typically, the valve is a duckbill valve arranged so that high pressure in the test cell acts to urge the valve closed. Moreover, the natural bias of the valve material also urges the valve to remain closed. A cannula can be inserted into the opening and push open the valve so that a substance passing through the cannula can be received in the test cell. When the cannula is removed, the duckbill valve closes behind the exiting cannula and re-seals the test call.

It has been found that the sealing surface of the duckbill valve can become contaminated with particulates from the chemistry in the test cell. The presence of contaminates can cause the valve not to seal properly. As a result, pressure in the test cell is undesirably lost.

Small reactors of this type often use stirrers within the vial in the test call to mix the reactants in the vial. Typically, the stirrers are driven by a magnetic drive that does not require any mechanical connection of the drive to the stirrer. The magnetic drives are located about the test cells. This makes a header that fits on top of the cells extremely heavy and not readily lifted off of the reactor for access to the vials.

### SUMMARY OF THE INVENTION

In one aspect of the present invention, a small scale reactor generally comprises a plurality of test cells for holding vials containing reactants to be reacted. A header is disposed over open upper ends of the test cells. An injection port assembly located on the header over at least one of the test cells is configured to permit sealed access to an interior of the test cell. A seal gate located between the injection port at least one of the test cells is sealed with the test cell and the header, and slidable between an open position in which the test cell is in fluid communication with the injection port assembly and a closed position in which the injection port assembly is blocked from fluid communication with the test call.

In another aspect of the present invention, a stirrer for a small scale reactor generally comprises a body sized and shaped for being received in a vial containing reactants to stir the reactants. A magnet is removably connected to the body to permit replacement of the magnet.

In still another aspect of the present invention, a small scale reactor generally comprises a test cell sized and shaped for receiving a vial containing reactants. A stirrer is sized and shaped to be received in a vial placed in the test cell. A driven magnet operatively connected to the stirrer is capable of causing the stirrer to rotate with respect to the test cell within the vial. A driving magnet located laterally of the driven magnet and outside of the test cell is mounted for rotation relative to the test cell thereby to induce rotation of the driven magnet in the test cell and rotation of the stirrer. A drive transmits rotational force to the driving magnet from a location located to the side of the driving magnet.

Other objects and features will be in part apparent and in part pointed out hereinafter.

### BRIEF DESCRIPTION OF THE DRAWINGS

FIG. 1 is a front side perspective view of a small scale research chemical reactor constructed according to the principles of the present invention;

FIG. 2 is a back side perspective view thereof;

FIG. 3 is a fragmentary, schematic vertical section of the reactor taken through the plane including lines 3-3 of FIG. 1;

FIG. 4 is an elevation view of the section of FIG. 3;

FIG. 5 is a perspective of a header and stirrers of the reactor, with one of the stirrers exploded from the header;

FIG. 6 is an enlarged, fragmentary, elevational section of an injection port of the header and showing an injection cannula received through the port;

FIGS. 7 and 8 are sections similar to FIG. 6 and showing a gate of the injection port in open and closed positions;

FIG. 9 is a section similar to FIG. 4, but showing an injection port of another embodiment of the reactor;

FIG. 10 is an enlarged perspective of a stirrer assembly of the reactor;

FIG. 11 is a perspective of a stirrer of the stirrer assembly;

FIG. 12 is an elevation of the stirrer;

FIG. 13 is an elevation of a stirrer of a second embodiment;

FIG. 14 is an elevation of a stirrer of a third embodiment;

FIG. 15 is a perspective of a portion of a reactor of a second embodiment;

FIG. 16 is a vertical section in perspective of the reactor portion of FIG. 15;

FIG. 17 is the section of FIG. 16 shown in elevation;

FIG. 18 is the perspective of FIG. 16, but with a header of the reactor exploded;

FIG. 19 is a perspective of a test vial and stirrer received in the vial;

FIG. 20 is a perspective of a portion of a reactor of a third embodiment, with a header of the reactor removed;

FIG. 21 is a vertical section of the reactor portion shown in FIG. 20;

FIG. 22 is a top plan view of the reactor portion of FIG. 20, showing gate valves of the reactor in a closed position;

FIG. 23 is the top plan view of FIG. 22, but with the gate valves in an open position;

FIG. 24 is a perspective of a portion of a reactor of the fourth embodiment;

FIG. 25 is the perspective of FIG. 24 with partes exploded;

FIG. 26 is a vertical section in perspective of the reactor of FIG. 24; and

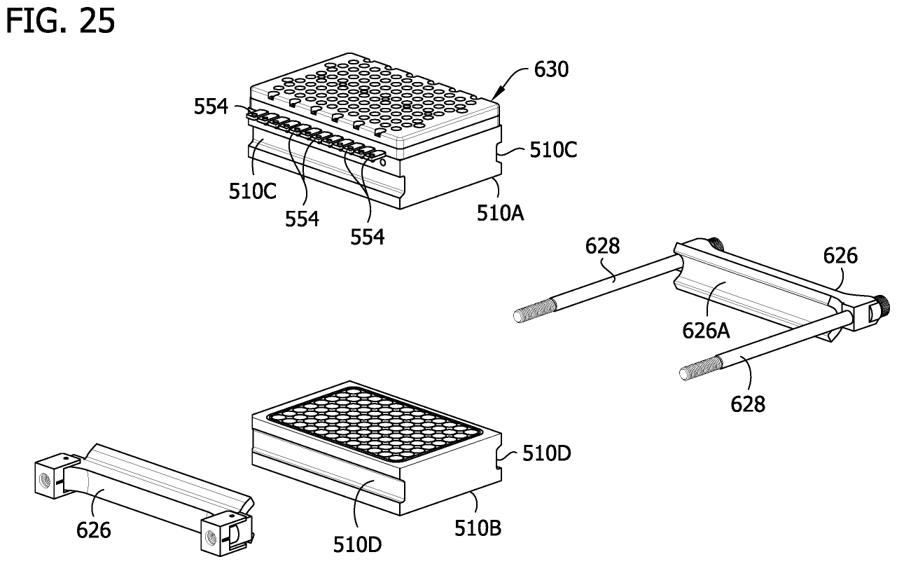

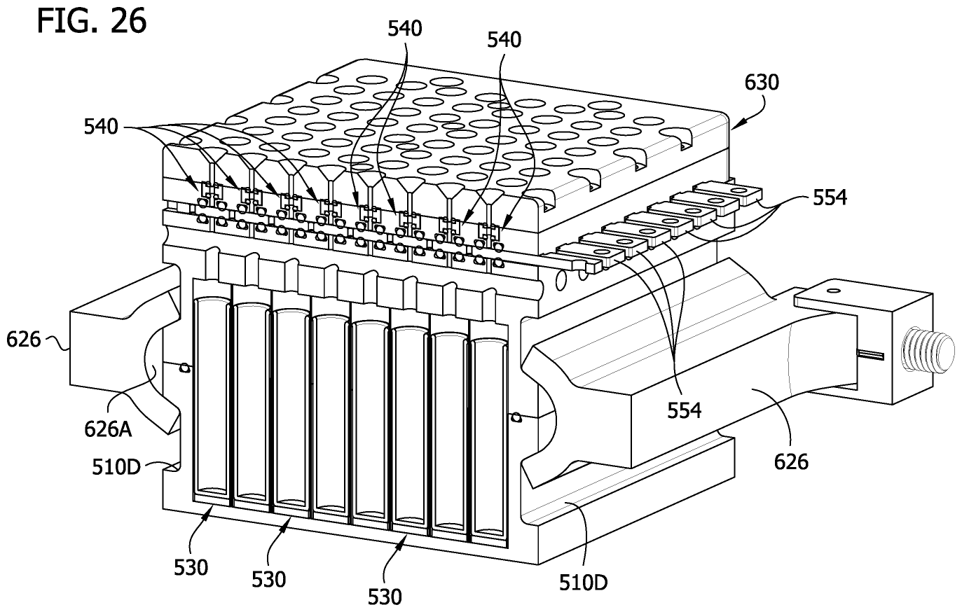

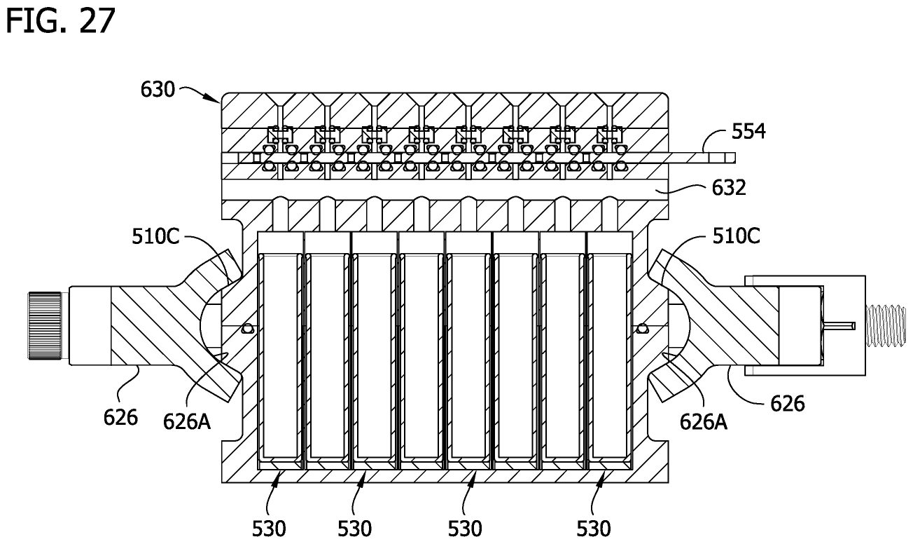

FIG. 25 is the section of FIG. 26 shown in elevation.

Corresponding reference numbers indicate corresponding parts throughout the views of the drawings.

### DETAILED DESCRIPTION

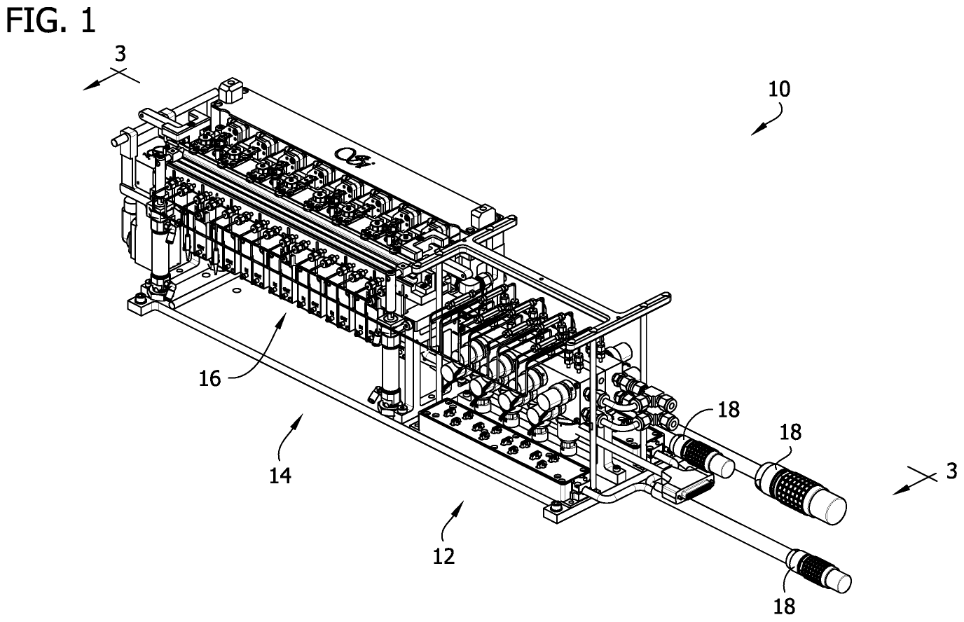

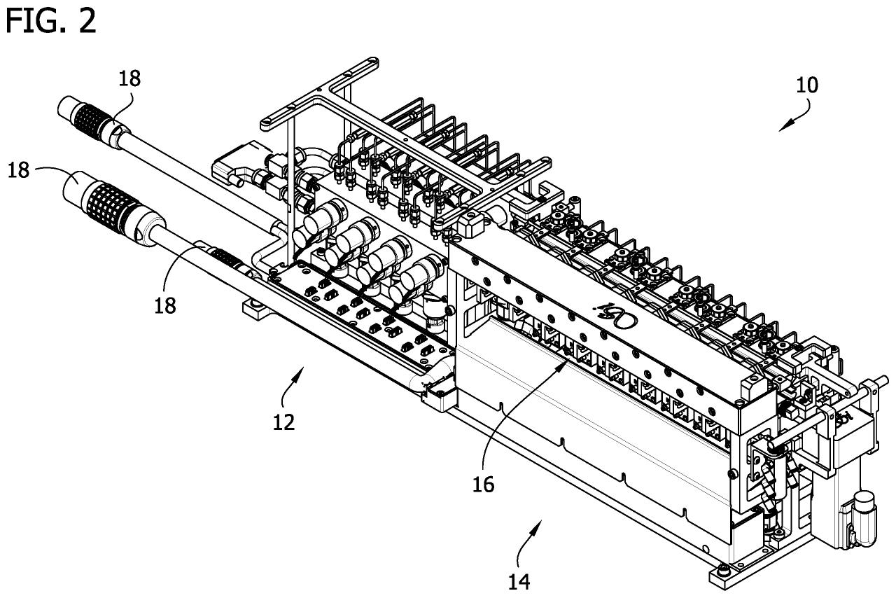

Referring now to the drawings and in particular to FIGS. 1 and 2, a small scale chemical reactor capable of carrying out multiple chemical reactions at the same time is generally indicated at 10. The reactor includes a gas distribution portion 12 constructed for selectively delivering and withdrawing gas from the test cells (described below) in operation. The reaction portion 14 include the test cells and components described more fully hereinafter. Sensors in the reactor portion 14 are capable of measuring temperature in the reactor portion. A pneumatic actuated assembly is provided to open and close injection ports (described hereinafter). An integrated pneumatic lift is operable to disengage a reactor top (header) from a reactor body. Coolant cells 16 in the reactor portion 14 can be used to withdrawn heat from the test cells as required. Heaters are also provided to supply energy for reaction, as needed. Electrical conduits 18 bring in power and control used in the reactor 10. The basic construction and operation of the reactor 10 will be understood by those of ordinary skill in the art.

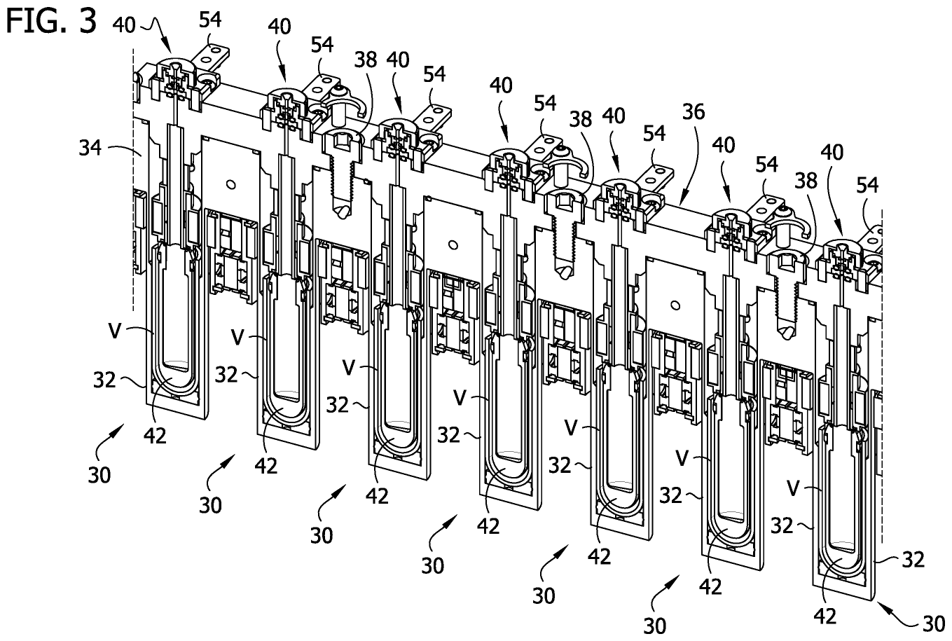

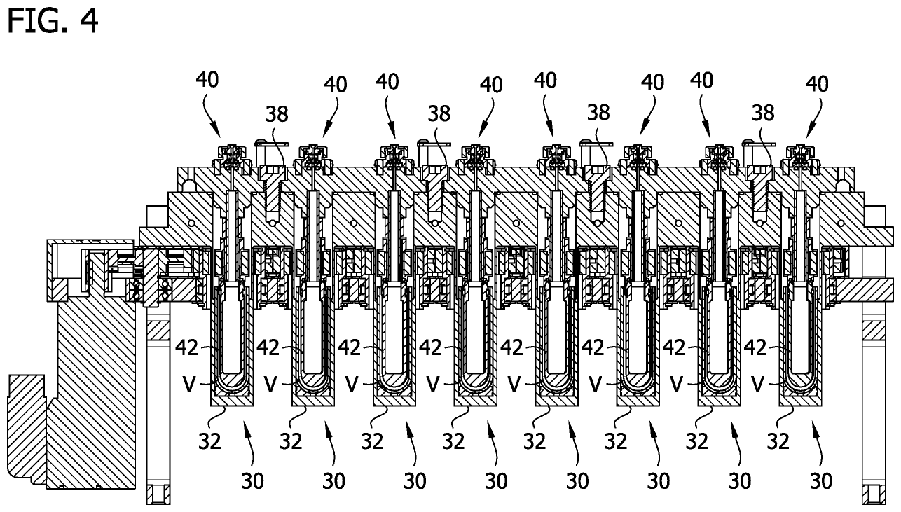

As may be seen in FIGS. 3 and 4, the reactor includes a plurality of test cells 30 including lower cylinders 32 having open tops. The cylinders 32 are supported by an upper support member 34. A header 36 is removably secured to the supper support member 34 by bolts 38. For each of the cylinders 32, there is an injection assembly 40 (“injection port”) mounted on top of the header 36 for use in injecting a substance into a testing vial V located in the cylinder. The testing vials V each contain a generally U-shaped stirrer 42 that is rotatable about a vertical axis in the vial for mixing reactants (not shown) contained in the vial. The stirrers 42 can be rotated in the vials V to mix the contents of the vials to facilitate chemical reaction. Rotation is driven using a contactless, mid-head magnetic drive system, described more fully below.

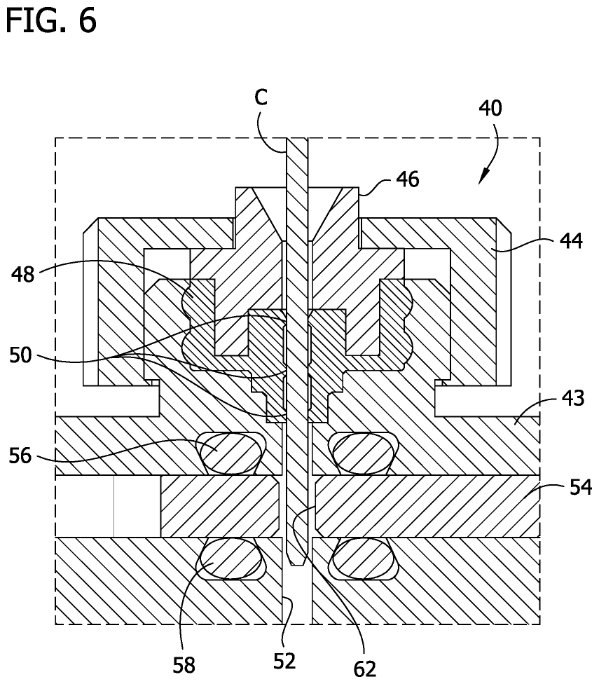

Each injection port 40 is constructed to receive a cannula C (e.g., a needle) through the injection port into fluid communication with the vial V while maintaining a gas-tight seal of the test cell 30. FIG. 6 below illustrates a fragment of the cannula C received through the injection port 40. The injection port comprises a base 43 having an opening through the base, and a cap 44 that is connected to the base. The cap 44 also has an opening. A fitting 46 is received in an enlarged upper portion of the opening in the base 43 and projects through the cap 44. The fitting 46 has a funnel shaped open top for guiding the leading end of the cannula C into the test cell 30 (and more particularly into the vial V held in the test cell). A port seal 48 located under the fitting 46 is shaped to receive and sealingly engage with the fitting. The fitting 46 has three spaced apart sealing lips 50 (broadly, “seals”) that engage and seal with the cannula C when the cannula is inserted through the injection port 40 into a passage 52 leading to the vial V. The port seal 48 is configured to close fluid access of the passage 52 when the cannula C is removed. More specifically, each of the lips 50 is constructed to close the passage 52 and hold against significant internal pressures from the test cell 30. In one embodiment, the lips 50 comprise needle seals which are capable of sealing around the cannula C when it is inserted through the port seal 48. The port seal is capable of holding internal pressures of up to and including about 1,500 psi (e.g., able to withstand without leakage or failure pressures of at least about 250 psi, 500 psi, 750 psi, 1,000 psi, 1,250 psi). In contrast, the prior art duckbill seals are believed to have been capable of withstanding no more than about 200 psi. The passage 52 extends through the injection port and through a seal gate 54 (light gray) located on the bottom of the injection port. The seal gate 54 is engaged with the injection port base 43 by a top seal 56 which maintains a fluid-tight seal (e.g., a gas tight seal). In this embodiment, the top seal is a top O-ring 56 received in an annular channel in the base 43 of the injection port 40 that extends around and is spaced radially from the passage 52. The seal gate 54 maintains a fluid-tight seal with the top of the header 36 by a bottom seal 58, which in this embodiment is a bottom O-ring. The bottom O-ring is received in an annular channel in the header 36. The annular channel, and hence the O-ring 58 are radially spaced from the passage 52

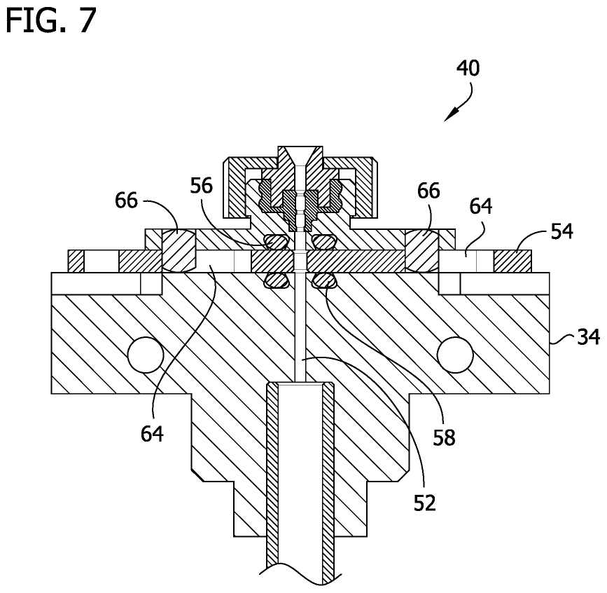

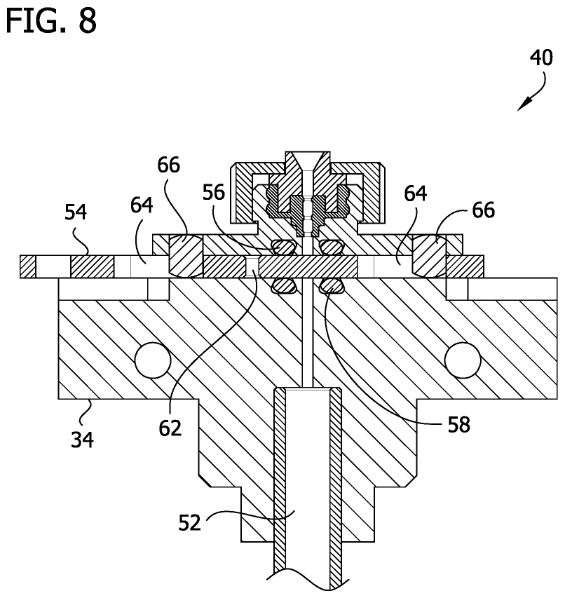

The seal gate 54 is operable to open and close the passage from the injection port 40. More particularly, the seal gate 54 seals the passage 52 from the injection port 40. As a result, the seal gate 54 shields the port seal 48 from the high pressure in the vial V, when closed. As shown in FIGS. 7 and 8 below, the seal gate 54 is movable between an open position (shown in FIGS. 6 and 7) and a closed position (shown in FIG. 8).

In FIG. 8, it may be seen that the seal gate 54 has been slid to the left so that an opening 62 previously aligned with the passage 52 in FIGS. 6 and 7 is moved to the left. The seal gate 54 thus blocks the passage 52 opening to the injection port 40 (and to the exterior of the test cell). As a result, the port seal 48 is protected from exposure to the chemicals in the vial V except when the seal gate is opened. This helps to delay loss of sealing efficacy that can occur when the lips 50 of the port seal 48 are continuously exposed to effluent from the test cell 30. The top and bottom O-rings 56, 58 prevent gas or other material from escaping from the test cell 30. Notably, the portions of the top and bottom O-rings 56, 58 that engage and seal with the seal gate 54 are not exposed to gas effluent trying to escape from the test cell 30. This is because the parts of the top and bottom O-rings 56, 58 that seal with the seal gate 54 (and with the injection port 30 and header) are constantly engaged by the seal gate, injection port and header so they are not exposed to the effluent. Accordingly, the top and bottom O-rings 56, 58 remain effective for a long period of time.

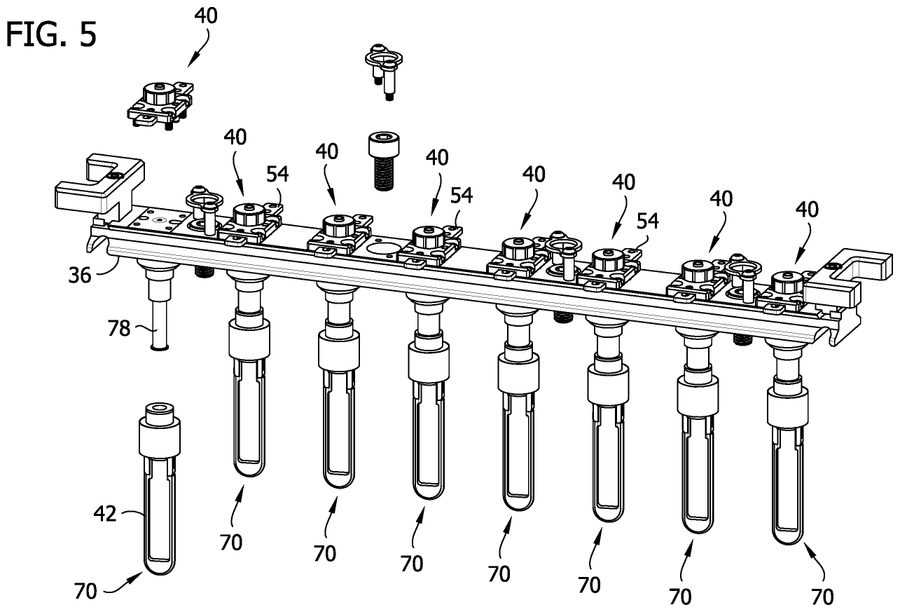

As may be seen in FIGS. 7 and 8, the seal gate 54 has a pair of slots 64 on opposite sides of the opening 62 in the seal gate. Tabs 66 are fixed to the injection port 30 and received in respective ones of the slots 64 to limit the sliding motion of the seal gate 54 with respect to the injection port 30 and the header 36. Each seal gate 54 extends out from the injection port 30 (see, FIG. 5) to a location where the seal gate can be grasped for pushing or pulling the gate to slide to the desired position. It is also envisioned that the seal gates 54 could be connected to an automated actuator (not shown) to move the seal gates simultaneously or independently.

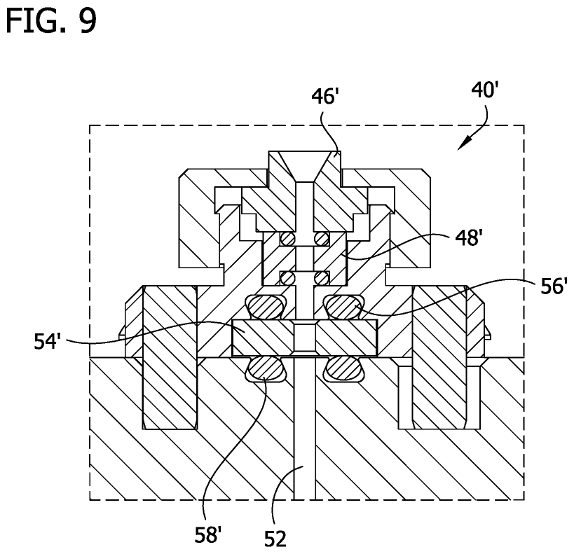

FIG. 9 shows the injection port 40′ with another version of the port seal 48. Corresponding parts of the injection port 40′ of FIG. 9 will be given the same reference numerals as for those parts in FIGS. 6-8, with the addition of a trailing prime. This port seal 48′ works in the same manner as the port seal 48 illustrated in FIGS. 6-8, but does not have the three, spaced apart lips 50 to engage the cannula C in three separate locations. The uniquely designed port seal 48′ of FIG. 9 can be readily and inexpensively made which can be advantageous for long term maintenance of the small scale reactor 10.

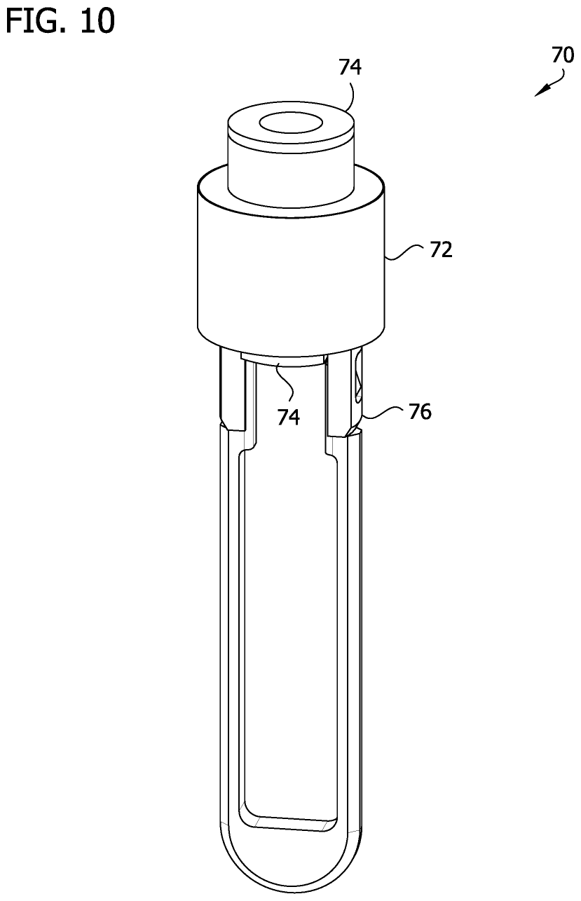

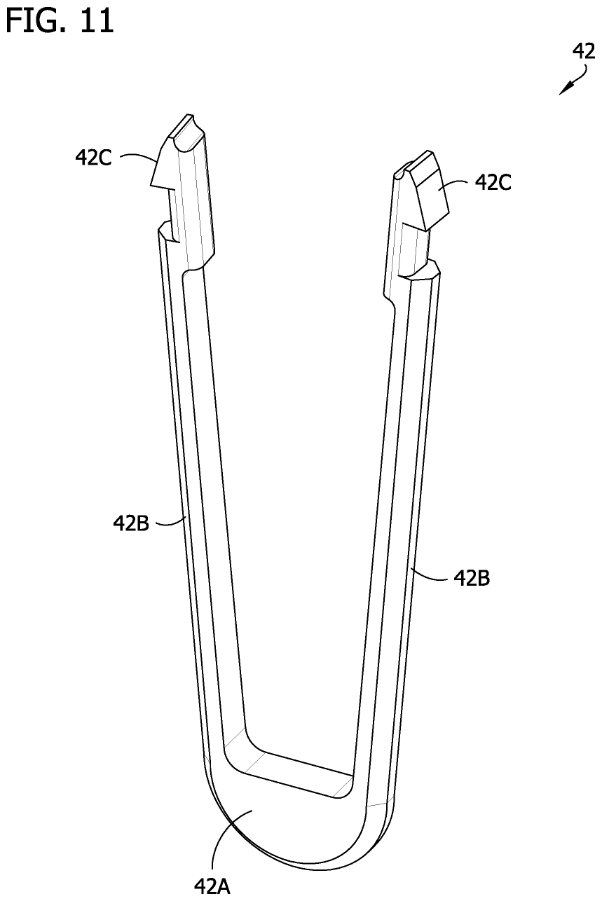

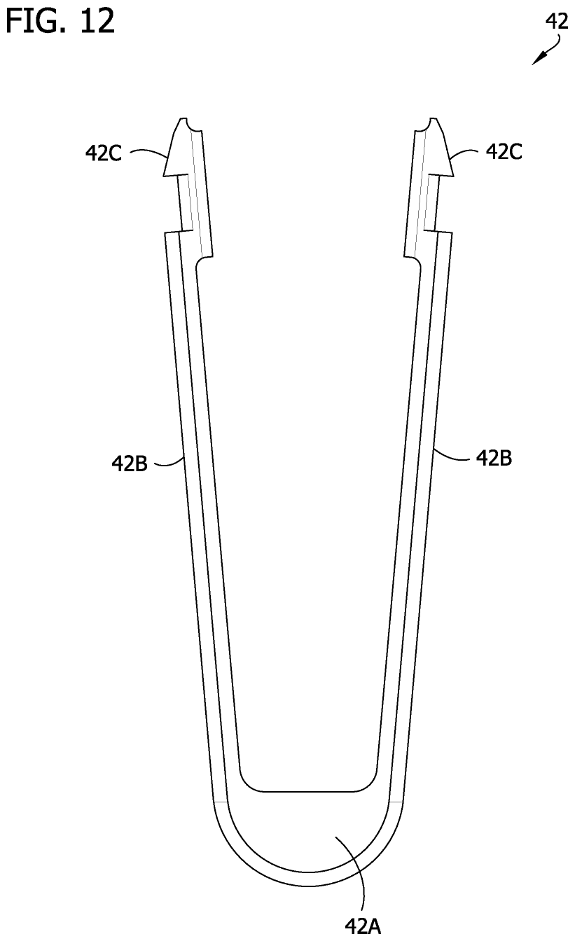

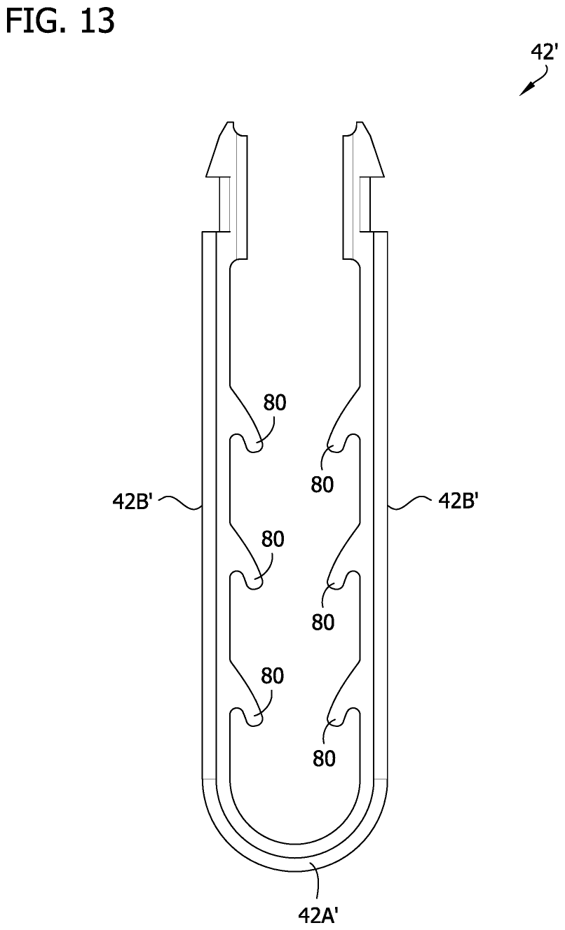

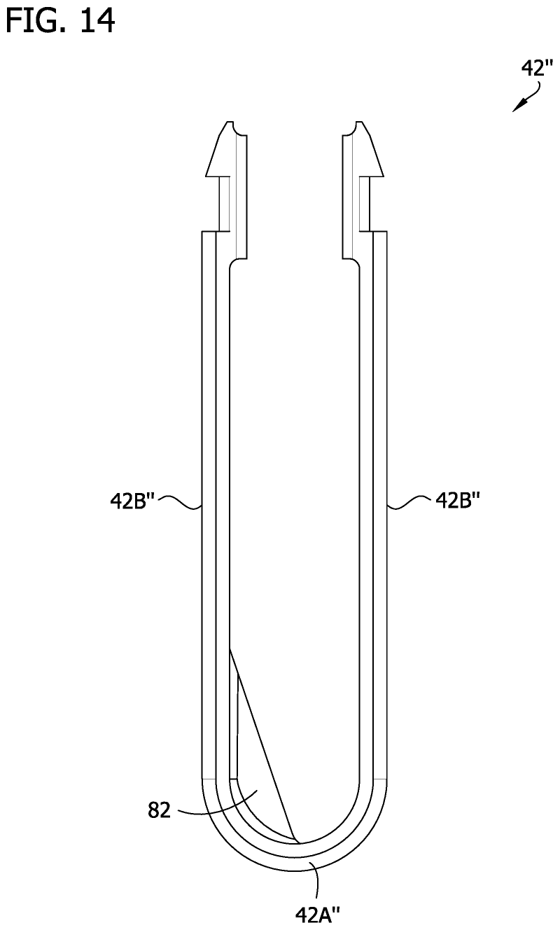

As shown in FIG. 5, it is possible to remove the header and stirrer assemblies 70 from the remainder of the small scale reactor 30, and from the vials V. In FIG. 5, the header 36 has been detached from the support member 34 (FIG. 3) by unscrewing the bolts 38. One of the injection ports 40 is shown detached and exploded from the header 36. Referring now also to FIG. 10, the stirrer assembly 70 is removed from the remainder of the small scale reactor 30. The stirrer assembly 70 includes a magnet 72, mounting sleeves 74, a clip 76 and the stirrer 42. The magnet 72 can be removed from the clip 76 and replaced as needed. The mounting sleeves 74 each receive a tubular stem 78 attached to the header 36 for rotation about the stem. When the magnet 72 is acted upon by a moving external magnetic field, the magnet, mounting sleeves 74, clip 76 and stirrer 42 all rotated conjointly on the stem 78 and with respect to the vial V so that the stirrer produces mixing in the vial. As may be seen in FIGS. 11 and 12, the stirrer 42 is biased to a slightly open (or V-shaped) configuration when not attached to the clip. The stirrer 42 comprises a base 42A and legs 42B extending up from the base so that the stirrer has a generally “U” shape. The “U” shape of the stirrer 42 is beneficial because when installed in the vial V, the central part of the vial is left open and unobstructed for the introduction of reactants into the vial. The distal end portions of each of the legs 42b includes an outwardly projecting hook 42C. The hooks are received in apertures in the clip 76. The bias of the legs 42B holds the hooks in openings of the clips in use.

The stirrers 42 can be formed in any suitable manner that facilitates mixing of the reactants received in the vial. FIGS. 11 and 12 below show two other embodiments of the stirrer, designated 42′ and 42″, respectively. The stirrer 42′ has finger-like projections 80 extending inward from each leg 42B′ at three positions along the height of the stirrer. Stirrer 42′ has a single diagonally extending fin 82 extending inward from the left leg 42B″ to the base 42A″. It will be understood that still other variations are possible. The user will select the stirrer to be used based on the nature of the reactants to be mixed in the vial V.

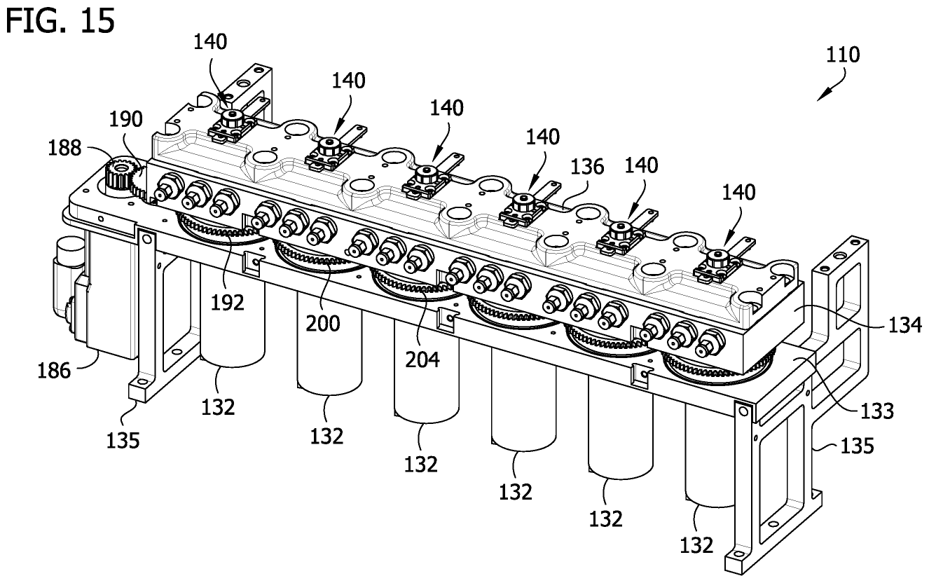

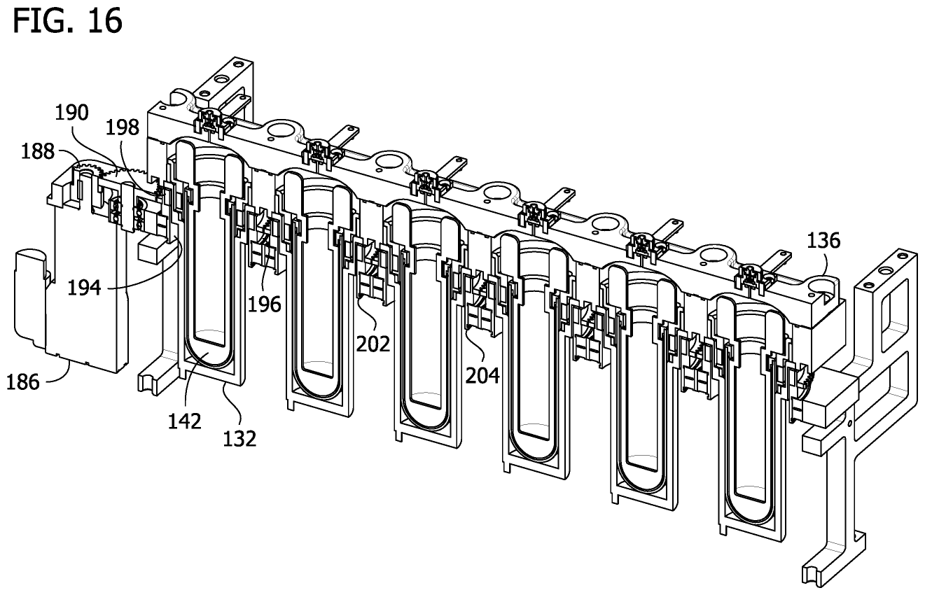

Referring to FIGS. 15-17 below, a small reactor 110 of a second embodiment constructed according to the principles of the present invention includes a frame mounting a number of test cell cylinders 132 on a mounting plate 133 that is supported by brackets 135 at either end. Corresponding parts of the reactor 110 will be given the same reference numerals as those used for the reactor 10 of the first embodiment, plus “100”. The frame further includes an upper plate 134 supported above the mounting plate 133, and a header 136 mounted on the top of the upper plate. The header mounts 136 a plurality of injection assemblies 140 (“injection ports”) having substantially the same structure and function as the injection ports 40 shown in FIGS. 1-8 and described above. The mounting plate 133 further attaches a primary mover in the form of an electric motor (and gear reduction box) 186 at one end of the mounting plate.

The electric motor 186 is part of a mid-head magnetically coupled stirrer system. The output shaft of the electric motor 186 mounts a gear 188 that is engaged with a reduction gear 190 mounted on the mounting plate 133. The reduction gear 190 meshes with a first test cylinder gear 192 mounted on a first exterior magnet bushing 194 that extends around an upper portion of the first test cylinder 132. The first exterior magnet bushing 194 is mounted on the mounting plate 133 by a bearing 196 received in an opening in the mounting plate. The first exterior magnet bushing 194 mounts a driver magnet 198 for conjoint rotation with the first exterior magnet bushing. The first test cylinder gear 192 is meshed with a second test cylinder gear 200 mounted on a second exterior magnet bushing 202 to impart rotational movement to the second exterior magnet bushing. The second test cylinder gear 200 is meshed with a third exterior magnet bushing 204 and so on so that exterior magnet bushings around all six test cylinders 132 are interconnected for rotation of stirrers 142 within the test cells 230. The construction and operation of each exterior magnet bushing is the same in the illustrated embodiment.

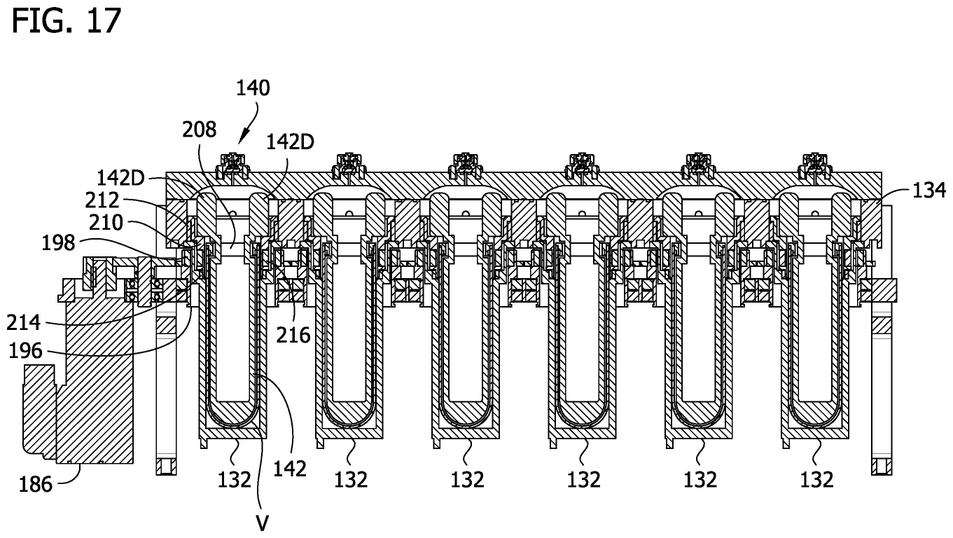

Referring again back to the first test cylinder 132, it may be seen in the section views of FIGS. 16 and 17 that the first test cylinder is mounted on the underside of the upper plate 134. Inside the first test cylinder 132, a vial V contains a stirrer 142. More particularly, the stirrer 142 is attached within the vial V by a collar 208 that is received in an upper end of the vial. The stirrer 142 includes C-shaped segment on each leg 142B that receive a portion of the collar 208. The collar thus prevents withdrawal of the stirrer 142 from the vial V while permitting the stirrer to rotate relative to the vial and collar 208. Enlarged ears or paddles 142D of the stirrer 142 project above the vial V and outward from the first test cylinder 132 and a first interior magnet bushing 210. The first interior magnet bushing is mounted by an upper bearing 212 to an opening in the upper plate 134. The first interior magnet bushing 210 is also mounted on the interior of the first test cylinder 132 of the first test cell 130 by a lower bearing 214. This permits the first interior magnet bushing 210 to rotate with respect to the upper plate 134, the first cylinder 132 and vial V. The stirrer 142 is connected to the first interior magnet bushing 210 so that the two rotate conjointly.

The first interior magnet bushing 210 mounts an annular driven magnet 216 for conjoint rotation with the first interior magnet bushing. Rotation of the first exterior magnet bushing 196 and drive magnet 198 induces rotation of the driven magnet 216 and thereby rotation of the first interior magnet bushing 210 and stirrer 142 in the vial V. The other five test cell cylinders 132 include interior magnet bushings 210, drive magnets 198, stirrers 142 and vials V as described for the first test cylinder.

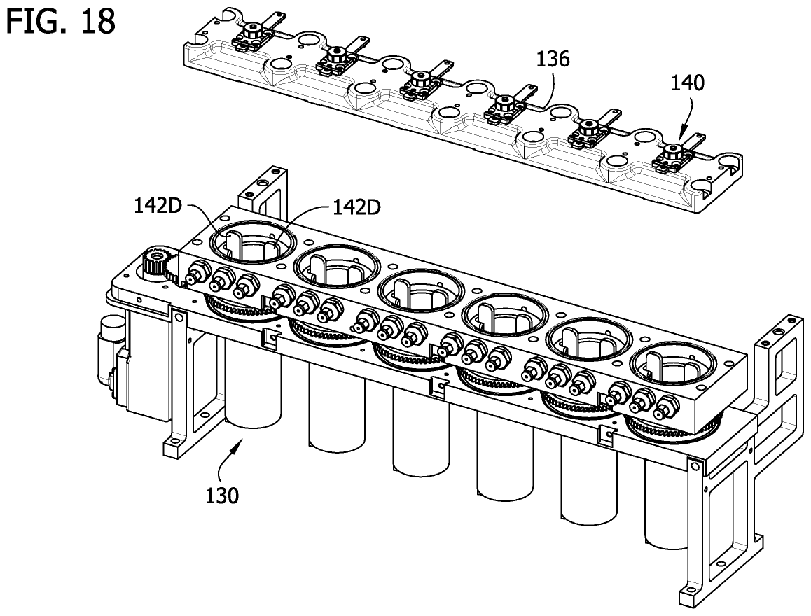

The header 136 is attached to the upper plate 134 by pairs of bolts (not shown). FIG. 18 below shows the header 136 detached and exploded from the remainder of the small scale reactor 110. One advantage of the mid-head magnetically coupled stirrer system is that nothing used to drive rotation of the stirrer is mounted on the header 136. Accordingly, the header can be extremely light weight (e.g., on the order of 5 lbs, on the order of 4.5 lbs or less). Therefore, it is easy for an operator to detach and lift off the header 136 from the upper plate 134, which can be particularly important if the reactor is housed in an ergonomically constrained environment (e.g., a fume hood or drybox). The removal of the header 136 exposes the interiors of the test cells 130. The vials V (and stirrers 142) can be removed from the test cylinders 132 through the openings in the upper plate 134 shown in FIG. 18. The mid-head stirrer system is completely undisturbed by removal of the vials V and stirrers 42.

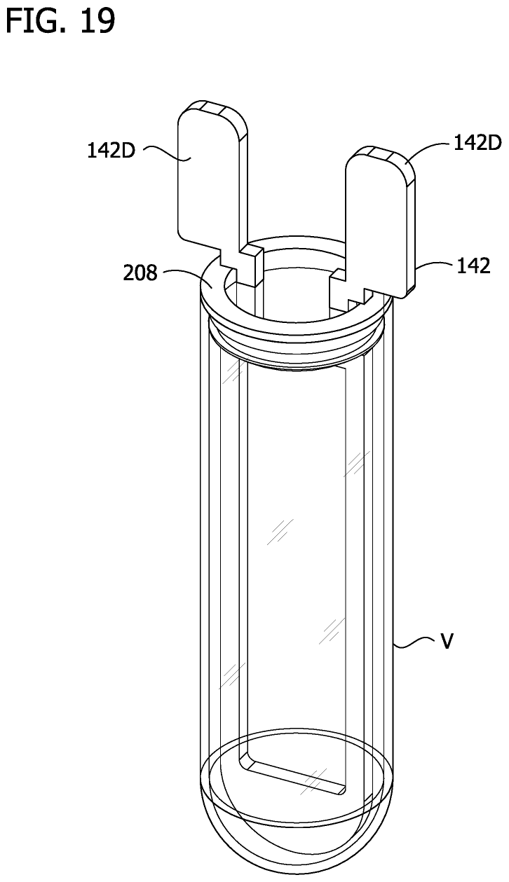

Referring to FIG. 19 above, the vial/stirrer assembly is particularly constructed to facilitate removal of the vial/stirrer assembly. As noted previously, the stirrer 142 has paddles 142D that present relatively large, flat surfaces projecting up from the top of the vial V. When the header 136 is removed these paddles 142D are close to the opening the upper plate 134 where they can be grasped to remove the vial/stirrer assembly from the test cell 130. In particular, the paddles 142D are designed to facilitate grasping and removing by automation, such as by a robot (not shown).

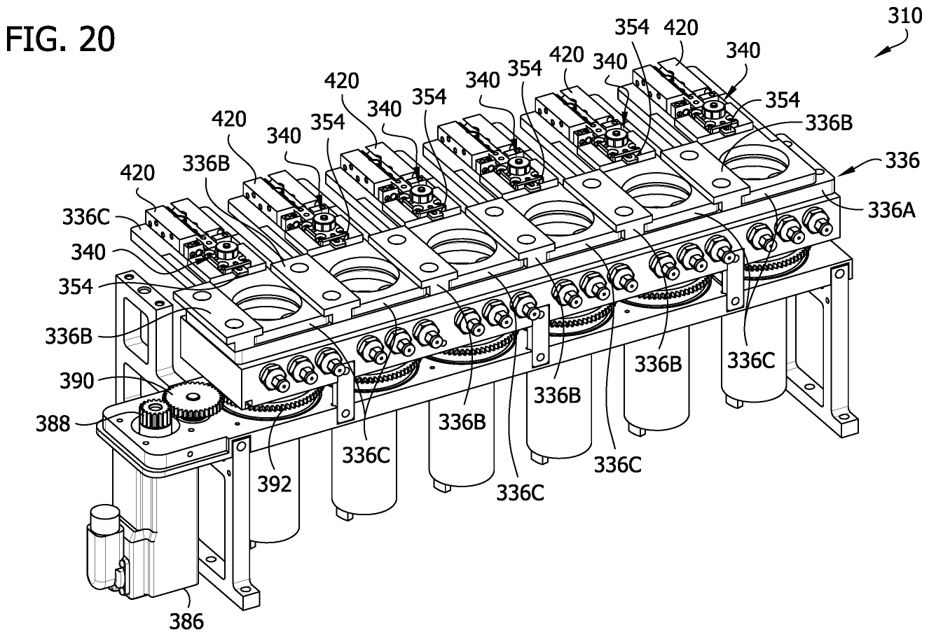

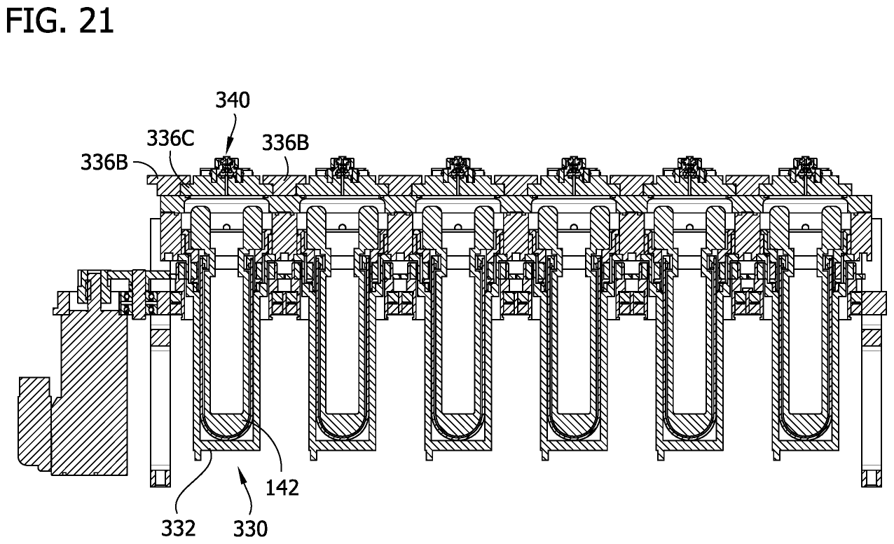

As shown in FIGS. 20-23, a third embodiment of the small scale reactor 310 has substantially the same construction as the small scale reactor 110 of the second embodiment. Parts of the reactor 310 corresponding to parts of the reactor 110 will be given the same reference numerals, plus “200”. The difference in the third embodiment is the header 336. The third embodiment comprises a header 336 which permits movement between an open position (shown in FIG. 20), and a closed position (shown in FIG. 21) that does not require the header to be detached from the upper plate 334.

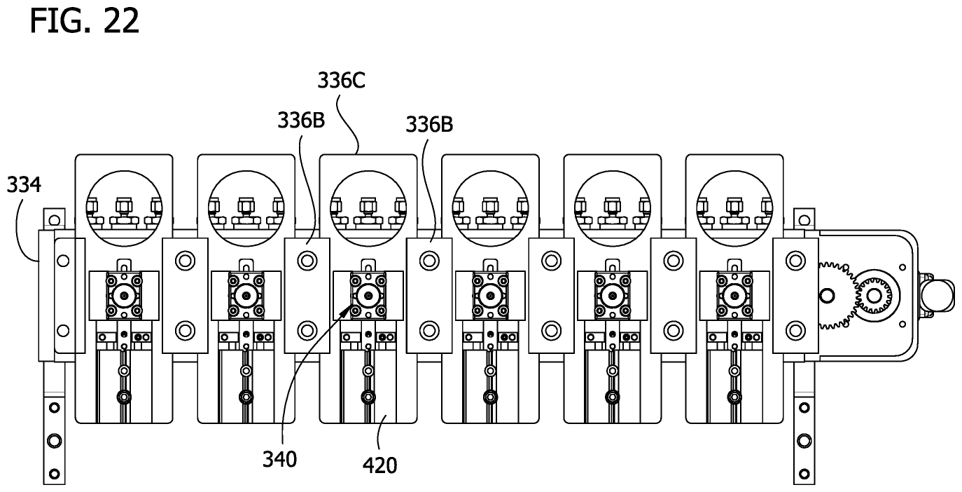

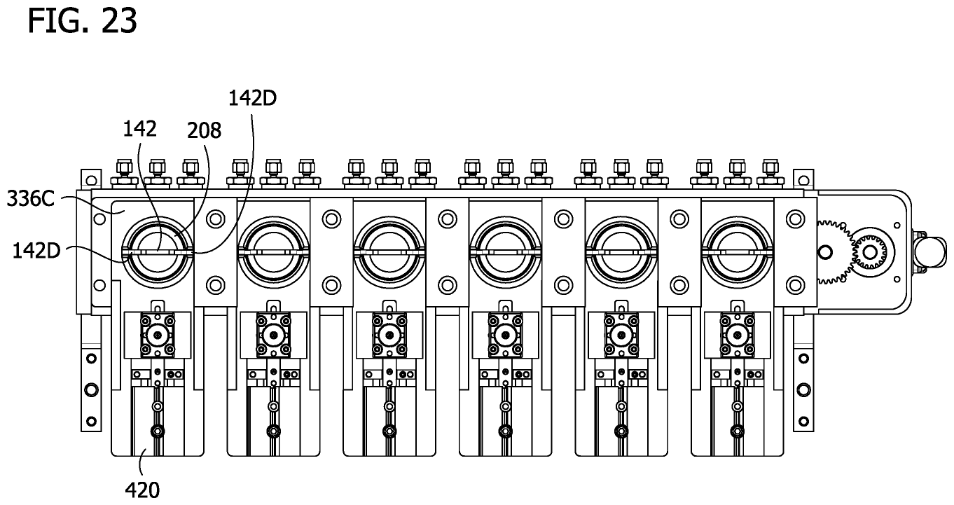

In the third embodiment, the header 336 includes a base plate 336A and T-shaped guides 336B mounted on the upper plate 334. Each adjacent pair of guides 336B receives a slider 336C on which an injection port 340 is mounted. The injection ports 340 may have the same construction and operation as previously described. The sliders 336C are each capable of independent movement relative to the guides 336B and base plate 336A. More specifically, the sliders 336C are each attached to a corresponding pneumatic cylinder 420. The pneumatic cylinders are selectively and independently operable to actuate the slide plates 336C to slide between open and closed positions. In that regard, in some embodiments the slider is made of a metal that is infusion coated with polytetrafluoroethylene. In another embodiment, a portion of the slide that contacts the O-rings is cut away and replaced with a block of polytetrafluoroethylene. In the open position, the injection port 340 is moved entirely out of the way, permitting unobstructed access to the test cylinder 332 for reaching the vial V. Thus, it is not necessary to remove the header 336 to access the interior of the cylinders 332. In the top plan view of FIG. 22 below, the 336B is in a position which closes the openings in the upper plate 334 and places the injection ports 340 in alignment with the openings in the upper plate. However, in another position, shown in FIG. 23 below, the slider 336B moves down (as oriented in FIGS. 22 and 23) to a position in which the openings in the upper plate 334 are exposed. The stirrers 142 may be seen, edge on, in FIG. 23. In particular, the paddles 142D of the stirrers 142 are exposed for grasping to remove the vial/stirrer assembly from the test cell 130.

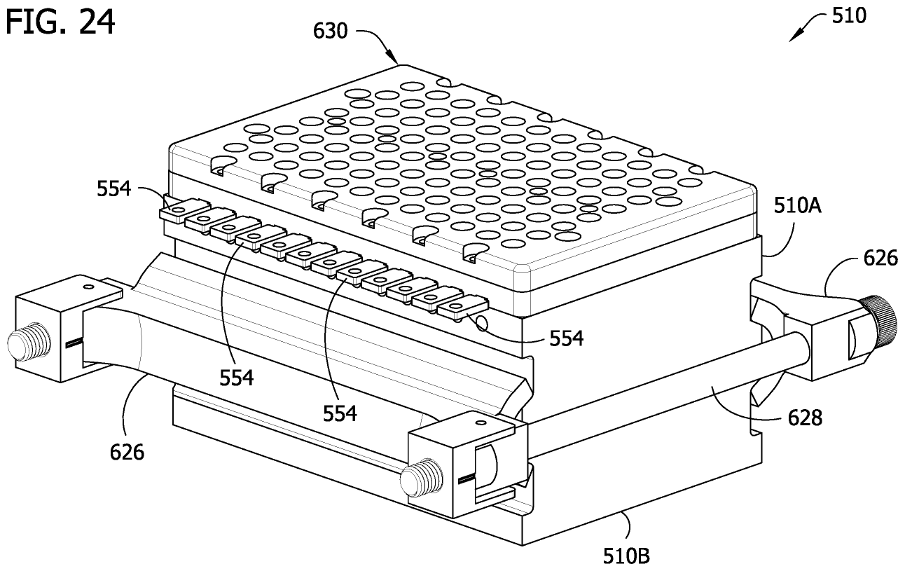

Referring now to FIGS. 24-27 below, a fourth embodiment of the small scale reactor 510 is a larger unit including 96 test cells that can receive 96 vials for conducting reactions. Parts of the reactor 510 corresponding to those parts of the reactor 10 of the first embodiment will be given the same reference numerals, plus 500. The small scale reactor 510 of the fourth embodiment includes an upper portion 510A and a lower portion 510B, which is best illustrated in FIG. 25 below. A seal (not shown) is present between the upper and lower portions 510A, 510B to seal the upper and lower portions around each test cell 530. A pair of clamping jaws 626 are provided to ensure that the upper and lower portions 510A, 510B are pushed firmly against each other and the intervening seal. Each of the upper and lower portions 510A, 510B includes angled cuts 510C, 510D on opposite sides that receive angled surfaces 626A of the corresponding clamping jaw 626 to wedge the upper and lower portions 510A, 510B toward each other. In the illustrated embodiment, the clamping jaws 626 are connected to each other by threaded rods 628, but other ways of securing the upper and lower portions 510A, 510B together may be used within the scope of the present invention. The threaded rods 628 can be used to draw the clamping jaws 626 toward each other so that the angled surfaces 626A of the jaws engages the angled cuts 510C, 510D of the upper and lower portions 510A, 510B to drive the upper and lower portions together.

As may be seen in FIGS. 26 and 27, injection ports 540 are disposed in a two-piece top part 630 mounted on the upper portion 510A. The injection ports 540 can have the same construction as the injection ports 40 described previously herein. Twelve seal gates 554 are disposed between the two-piece top part 630 and an upper surface of the upper portion 510A. Each seal gate 554 services eight injection ports 540. It will be understood that in the position shown in FIGS. 26 and 27, the seal gate 554 blocks communication between the injection ports 540 and the test cells 530. Each seal gate 554 can be slid to another position in which the path through the injection ports 540 to the test cells 530 is open. In that position, all eight test cells 530 can be serviced at the same time. This could be done by a robot or manually.

As best seen in FIG. 27, each row of eight test cells 530 communicates with a common manifold 632. The manifold can communicate with an environment outside of the reactor. This could be used, for example, to control pressure in the eight test cells 530.

### OTHER STATEMENTS OF THE INVENTION

A. A stirrer for a small scale reactor comprising a U-shaped body including opposing legs with free upper ends, the free upper ends of the opposing legs being formed for connection to a mount for mounting the stirrer in a small scale reactor whereby a central portion between the legs is open to permit access into a space of the stirrer.

B. A small scale reactor comprising:
a test cell having an open top sized large enough to receive a vial through the opening into and out of the test cell, the test cell being size and shaped for receiving the vial containing reactants;
a slider located at the open top and movable relative to the open top for blocking and opening the open top.

B1. A small scale reactor as set forth in claim B further comprising an injection port assembly mounted on the slider.

C. A test vial assembly for use in a small scale reactor, the test vial assembly comprising:
a test vial having an open top;
a stirrer in the test vial rotatable relative to the test vial for stirring reactants in the vial;
a retainer for holding the stirrer in the vial whereby the vial can be moved by griping the stirrer.

D. A small scale reactor comprising:
a plurality of test cells having open tops, each sized large enough to receive a vial through the opening into and out of the test cell;
a header received over the open tops of the test cells for use in closing the open tops of the test cells, the header weighing less than or equal to about 4.5 lbs.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “forward” and “rearward” and variations of these terms, or the use of other directional and orientation terms, is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A small scale reactor comprising:
a plurality of test cells for holding vials containing reactants to be reacted;
a header over open upper ends of the test cells;
an injection port assembly located on the header over at least one of the test cells, the injection port assembly being configured to permit sealed access to an interior of the test cell;
a seal gate located between the injection port at least one of the test cells, the seal gate being sealed with the test cell and the header and slidable between an open position in which the test cell is in fluid communication with the injection port assembly and a closed position in which the injection port assembly is blocked from fluid communication with the test call.

2. The small scale reactor of claim 1 wherein the seal gate comprises a plate having opposite first and second surfaces, the first surface being sealingly engaged with the header and the second surface being sealingly engaged with the injection port assembly.

3. The small scale reactor of claim 2 wherein the injection port assembly comprises a port seal having a through hole and seals in the through hole for sealing the through hole against fluid passage, the seals being nondestructively deformable to permit passage of a cannula through the port seal for injecting a substance into the small scale reactor.

4. The small scale reactor of claim 3 wherein the seal gate blocks fluid communication between the test cell and the seals of the port seal in the closed position of the seal gate.

5. The small scale reactor of claim 1 further comprising a slider mounted for sliding movement with respect to the header, the injection port being mounted on the slider for movement with the slider.

6. The small scale reactor of claim 1 wherein the header weighs less than or equal to about 4.5 lbs.

7. The small scale reactor of claim 1 wherein the injection port assembly is configured to permit sealed access to an interior of the test cell, the injection port assembly being configured to withstand fluid pressure in the test cell of at least about 250 psi.

8. A stirrer for a small scale reactor comprising a body sized and shaped for being received in a vial containing reactants to stir the reactants, a magnet removably connected to the body to permit replacement of the magnet.

9. The stirrer of claim 8 wherein the body is constructed for releasably clip in connection with the magnet.

10. The stirrer of claim 9 wherein the body is resiliently deformable and shaped so that when the body is clipped to the magnet, the body is resiliently deformed from a relaxed position.

11. The stirrer of claim 8 wherein the body is U-shaped and has opposing legs with free upper ends, the free upper ends of the opposing legs being formed for connection to a mount for mounting the stirrer in a small scale reactor whereby a central portion between the legs is open to permit access into a space of the stirrer.

12. The stirrer of claim 11 further comprising gripping paddles mounted at distal ends of the legs and arranged for gripping the stirrer.

13. The stirrer of claim 8 further comprising a retainer for holding the stirrer in the vial whereby the vial can be moved by griping and moving the stirrer.

14. A small scale reactor comprising:
a test cell sized and shaped for receiving a vial containing reactants;
a stirrer sized and shaped to be received in a vial placed in the test cell;
a driven magnet operatively connected to the stirrer for use in causing the stirrer to rotate with respect to the test cell within the vial;
a driving magnet located laterally of the driven magnet and outside of the test cell; the driving magnet being mounted for rotation relative to the test cell thereby to induce rotation of the driven magnet in the test cell and rotation of the stirrer;
a drive transmitting rotational force to the driving magnet from a location located to the side of the driving magnet.

15. The small scale reactor of claim 14 further comprising a frame mounting the test cells, the frame including a top, a bottom and sides, the drive being mounted on one of the sides of the frame.

16. The small scale reactor of claim 14 a first gear operatively connected to the drive magnet for conjoint rotation with the drive magnet.

17. The small scale reactor of claim 16 further comprising a drive magnet bushing mounting the drive magnet, the first gear being connected to the drive magnet bushing.

18. The small scale reactor of claim 16 further comprising a second test cell, a second drive magnet, a second driven magnet, a second stirrer and a second gear operatively connected to the second gear for conjoint rotation with the second drive magnet, the second gear being meshed with the first gear.
